(19) United States
(12) Patent Application Publication
(10) Pub. No.: US 2026/0105893 A1
(43) Pub. Date: Apr. 16, 2026

(54) DISPLAY DEVICE AND OPERATING METHOD OF DISPLAY DEVICE

(71) Applicant: ELECTRONICS AND TELECOMMUNICATIONS RESEARCH INSTITUTE, Daejeon (KR)

(72) Inventors: Yongduck KIM, Daejeon (KR); Jae-Eun PI, Daejeon (KR); Seung Youl KANG, Daejeon (KR); Yong Hae KIM, Daejeon (KR); Hee-ok KIM, Daejeon (KR); Jong-Heon YANG, Daejeon (KR); Seong-Mok CHO, Daejeon (KR); Ji Hun CHOI, Daejeon (KR); Chi-Sun HWANG, Daejeon (KR)

(73) Assignee: ELECTRONICS AND TELECOMMUNICATIONS RESEARCH INSTITUTE, Daejeon (KR)

(21) Appl. No.: 19/348,666

(22) Filed: Oct. 2, 2025

(30) Foreign Application Priority Data
Oct. 10, 2024 (KR) 10-2024-0137632
Jul. 3, 2025 (KR) 10-2025-0089356

(51) Int. Cl. G09G 3/3266; G09G 3/3275

(52) U.S. Cl. CPC G09G 3/3266; G09G 3/3275; G09G 2300/0426; G09G 2300/0876; G09G 2310/08; G09G 2340/16

(57) ABSTRACT

A display device includes pixels arranged in rows and columns, a gate driver connected to the rows of the pixels through first scan lines and second scan lines respectively corresponding to the first scan lines, a data driver connected to the columns of the pixels through data lines. The pixels receive target voltages through the data lines in a first interval and charge pixel voltages based on the target voltages in a second interval.

### CROSS-REFERENCE TO RELATED APPLICATIONS

This application claims priority under 35 U.S.C. § 119 to Korean Patent Application No. 10-2024-0137632 filed on Oct. 10, 2024, and Korean Patent Application No. 10-2025-0089356 filed on Jul. 3, 2025, in the Korean Intellectual Property Office, the disclosures of which are incorporated by reference herein in their entireties.

### BACKGROUND

The present disclosure relates to a display device, and more particularly, to a display device using a frame update method and an operating method of the display device.

Recently, various display devices such as a liquid crystal display, an organic light emitting diode display, an electro wetting display device, and an electrophoretic display device have been developed.

Generally, a display device includes a display panel including a plurality of pixels for displaying an image, a gate driver block for providing gate signals to the pixels, and a data driver block for providing data signals to the pixels. The pixels receive the gate signals through a plurality of scan lines (or gate lines). The pixels receive the data signals through a plurality of data lines in response to the gate signals. The pixels display a grayscale corresponding to the data signal.

### SUMMARY

An object of the present disclosure is to provide a display device using a frame update method and an operating method of the display device.

According to an embodiment of the present disclosure, a display device includes pixels arranged in rows and columns, a gate driver connected to the rows of the pixels through first scan lines and second scan lines respectively corresponding to the first scan lines, a data driver connected to the columns of the pixels through data lines. The pixels receive target voltages through the data lines in a first interval and charge pixel voltages based on the target voltages in a second interval.

According to an embodiment of the present disclosure, the pixels include first transistors including a gate connected to a corresponding first scan line among the first scan lines, a first terminal connected to a corresponding data line among the data lines, and a second terminal, and second transistors including a gate connected to a corresponding second scan line among the second scan lines, a first terminal connected to the second terminal of the first transistors, and a second terminal.

According to an embodiment of the present disclosure, the second transistors are simultaneously turned on based on a voltage of the corresponding second scan line among the second scan lines.

According to an embodiment of the present disclosure, the pixels include first capacitors and second capacitors. Each of the first capacitors is connected to the second terminal of a corresponding first transistor among the first transistors and the first terminal of a corresponding second transistor among the second transistors. Each of the second capacitors is connected to the second terminal of a corresponding second transistor among the second transistors.

According to an embodiment of the present disclosure, the target voltages represent data voltages for inputting data corresponding to a first frame.

According to an embodiment of the present disclosure, in the first interval, the first transistors are sequentially turned on based on a voltage of the corresponding first scan line among the first scan lines.

According to an embodiment of the present disclosure, in response to the first transistors being turned on in the first interval, the first capacitors charge the target voltages.

According to an embodiment of the present disclosure, in response to the second transistors being turned on in the second interval, the second capacitors charge the pixel voltages based on the target voltages.

According to an embodiment of the present disclosure, in a third interval, the pixels receive reset voltages through the data lines and initialize data corresponding to the first frame in response to the reset voltages.

According to an embodiment of the present disclosure, the pixels display the first frame in the second interval.

According to an embodiment of the present disclosure, each of the target voltages includes a reset voltage for initializing data corresponding to a first frame and a data voltage for inputting data corresponding to a second frame.

According to an embodiment of the present disclosure, in the first interval, the first transistors are sequentially turned on based on a voltage of the corresponding first scan line among the first scan lines.

According to an embodiment of the present disclosure, in response to the first transistors being turned on in the first interval, the first capacitors charge the target voltages.

According to an embodiment of the present disclosure, in the first interval, the second capacitors are in a charged state with first pixel voltages corresponding to the first frame. The pixels display the first frame.

According to an embodiment of the present disclosure, in response to the second transistors being turned on in the second interval, the second capacitors are charged with second pixel voltages corresponding to the second frame.

According to an embodiment of the present disclosure, in response to the second transistors being charged with the second pixel voltages in the second interval, the pixels display the second frame.

According to an embodiment of the present disclosure, a method of operating a display panel including the first transistors, the second transistors, the first capacitors, and the second capacitors includes sequentially turning on the first transistors through first scan lines in a first interval, receiving target voltages through data lines by the first transistors in response to turning on the first transistors in the first interval, charging the target voltages by the first capacitors in the first interval, simultaneously turning on the second transistors in a second interval, and charging pixel voltages based on the target voltages by the second capacitors in response to the second transistors being turned on in the second interval.

According to an embodiment of the present disclosure, the target voltages represent data voltages for inputting data corresponding to a first frame.

According to an embodiment of the present disclosure, the method further includes receiving reset voltages through the data lines by the first transistors in a third interval, and initializing data corresponding to the first frame in response to the reset voltages.

According to an embodiment of the present disclosure, each of the target voltages includes a reset voltage for initializing data corresponding to a first frame and a data voltage for inputting data corresponding to a second frame.

### BRIEF DESCRIPTION OF THE FIGURES

The above and other objects and features of the present disclosure will become apparent by describing in detail embodiments thereof with reference to the accompanying drawings.

FIG. 1 illustrates an example of a display device according to an embodiment of the present disclosure.

FIG. 2 illustrates an example of a first pixel.

FIG. 3 illustrates an example of an operation of a display panel implemented with the first pixel of FIG. 2.

FIG. 4 illustrates an example of a second pixel.

FIG. 5 illustrates an example of a display panel implemented with the second pixel of FIG. 4.

FIG. 6 illustrates a first operating method of the display panel of FIG. 5.

FIG. 7 illustrates a second operating method of the display panel of FIG. 5.

### DETAILED DESCRIPTION

Hereinafter, embodiments of the present disclosure may be described in detail and clearly to such an extent that an ordinary one in the art easily implements the present disclosure.

Hereinafter, the preferred embodiments of the present disclosure will be described in detail with reference to the accompanying drawings. The advantages, features, and methods of achieving the present invention will become more apparent from the following detailed description taken in conjunction with the accompanying drawings. However, it should be understood that the present invention is not limited to the embodiments described herein and may be embodied in various other forms. Rather, the embodiments introduced here are provided to make the disclosed content thorough and complete, and to ensure that the concepts of the disclosure are sufficiently conveyed to those skilled in the art, and the disclosure is defined only by the scope of the claims. Throughout the specification, the same reference numerals refer to the same components.

The terms used in the specification are for the purpose of describing the embodiments and are not intended to limit the disclosure. In this specification, the singular form includes the plural form unless specifically stated otherwise in the context. The terms ‘comprise’ and/or ‘comprising’ used in the specification do not exclude the presence or addition of one or more other components, actions, and/or elements. Furthermore, since it is based on preferred embodiments, the reference numerals presented in the description are not necessarily limited by the order of presentation.

The embodiments described in this specification will be explained with reference to ideal examples such as cross-sectional and/or plan views of the disclosure. In the drawings, the thickness of the layers and regions may be exaggerated for the effective explanation of the technical content. Therefore, the shape of the example may be altered due to manufacturing techniques and/or tolerances. Thus, the embodiments of the present disclosure are not limited to the specific forms illustrated, but include changes in the shape created according to the manufacturing process.

Components that are described in the detailed description with reference to the terms “unit”, “module”, “block”, “-er or -or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

In the present disclosure, each of the phrases such as “A or B,” “at least one of A and B,” “at least one of A or B,” “A, B, or C,” “at least one of A, B, and C,” and “at least one of A, B, or C” is intended to encompass any one of the listed elements and all possible combinations thereof.

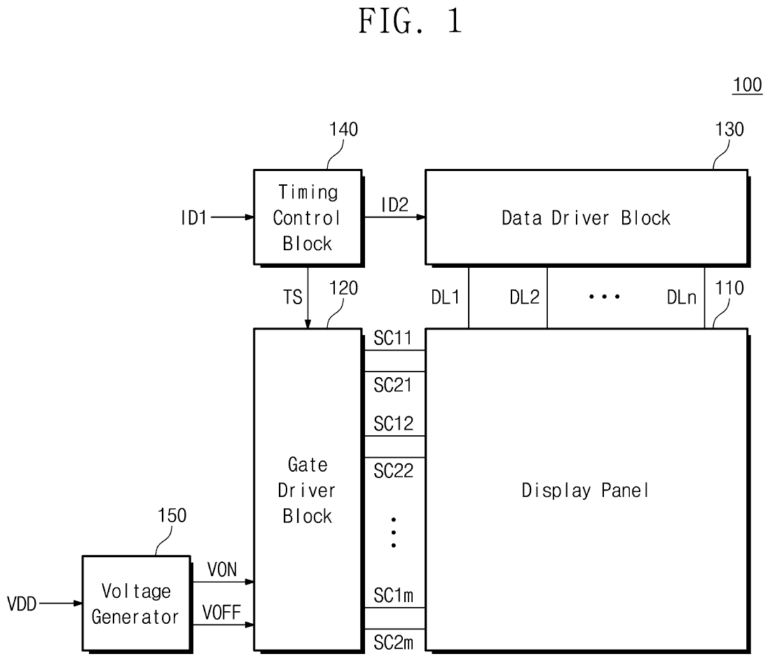

FIG. 1 illustrates an example of a display device according to an embodiment of the present disclosure. Referring to FIG. 1, a display device 100 may include a display panel 110, a gate driver block 120, a data driver block 130, a timing control block 140, and a voltage generator 150.

The display panel 110 may be various types of display panels such as a liquid crystal display panel (LCD), an electrophoretic display panel, an electrowetting display panel, a plasma display panel (PDP), or an organic light-emitting diodes (OLED) panel. Hereinafter, the display panel 110 will be described with a liquid crystal display panel as an example.

The display panel 110 may include pixels arranged in rows (e.g., m rows) and columns (e.g., n columns). The rows of pixels may be connected to first scan lines SC11 to SC1m and second scan lines SC21 to SC2m, which respectively correspond to the first scan lines SC11 to SC1m. The columns of pixels may be connected to data lines DL1 to DLn.

Each of the pixels may be configured to adjust brightness in response to control from a corresponding first scan line among the first scan lines SC11 to SC1m, a corresponding second scan line among the second scan lines SC21 to SC2m, and the data lines DL1 to DLn. In an embodiment, the pixels may receive data voltages from the data lines DL1 to DLn in response to gate signals received from the first scan lines SC11 to SC1m or the second scan lines SC21 to SC2m. The pixels may display a grayscale corresponding to the data voltages. In an embodiment, the gate signals may include a gate-on voltage VON and a gate-off voltage VOFF.

The gate driver block 120 may be connected to the rows of pixels through the first scan lines SC11 to SC1m and through the second scan lines SC21 to SC2m. In an embodiment, the gate driver block 120 may sequentially select the rows of pixels through the first scan lines SC11 to SC1m in response to control (e.g., a timing signal TS) from the timing control block 140.

The gate driver block 120 may control the brightness of the pixels PX or the emission timing of the pixels PX through the second scan lines SC21 to SC2m in response to control (e.g., a timing signal TS) from the timing control block 140.

The data driver block 130 may receive second image data ID2 from the timing control block 140. The second image data ID2 may include brightness information of the pixels in one row. The data driver block 130 may apply the data voltages to the data lines DL1 to DLn in response to control from the timing control block 140. For example, the data driver block 130 may convert the second image data ID2 into the data voltages in analog form in response to control from the timing control block 140. The data driver block 130 may output the brightness information to be input to the pixels of the selected row as the data voltages based on the second image data ID2.

The timing control block 140 may control operation timings of the gate driver block 120 through the timing signal TS. The timing control block 140 may receive first image data ID1 from an external device. The timing control block 140 may provide the first image data ID1 to the data driver block 130 as second image data ID2, either converted into a form suitable for display or unconverted.

The voltage generator 150 may receive a power supply voltage VDD from an external source and generate a plurality of voltages required to operate the display device 100. For example, the plurality of voltages required to operate the display device 100 may include the gate-on voltage VON and the gate-off voltage VOFF. The gate-on voltage VON and the gate-off voltage VOFF may be provided to the gate driver block 120. In an embodiment, the voltage generator 150 may generate a common voltage. The voltage generator 150 may provide the common voltage to the display panel 110.

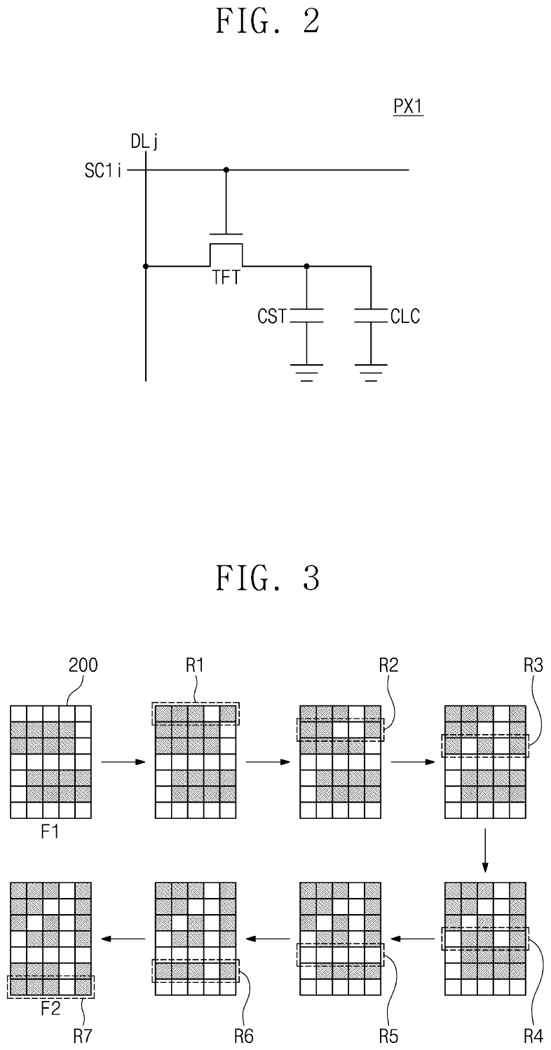

FIG. 2 illustrates an example of a first pixel. Referring to FIG. 1 and FIG. 2, a first pixel PX1 may include a thin-film transistor TFT including a gate connected to a corresponding first scan line SC1i among first scan lines SC11 to SC1m, a first terminal connected to a corresponding data line DLj among data lines DL1 to DLn, and a second terminal.

The thin-film transistor TFT may be referred to as a switching element. For example, when a row of the first pixel PX1 is selected, a gate driver block 120 may adjust a voltage of the first scan line SC1i to a high level (e.g., a first level or a turn-on level). The thin-film transistor TFT may be turned on in response to the voltage of the first scan line SC1i that is the high level. The turned-on thin-film transistor TFT may receive a data voltage through the data line DLj. The thin-film transistor TFT may provide the data voltage to a storage capacitor CST and a liquid crystal capacitor CLC.

For example, the gate driver block 120 may adjust the voltage of the first scan line SC1i to a low level (e.g., a second level or a turn-off level). The thin-film transistor TFT may be turned off in response to the voltage of the first scan line SC1i that is the low level.

The first pixel PX1 may further include the storage capacitor CST connected between the second terminal of the thin-film transistor TFT and a first ground node to which a ground voltage is supplied. The storage capacitor CST may receive the data voltage from the thin-film transistor TFT and charge a voltage corresponding to the data voltage. The storage capacitor CST may supplement a charging voltage of the liquid crystal capacitor CLC.

The first pixel PX1 may further include the liquid crystal capacitor CLC connected between the second terminal of the thin-film transistor TFT and a second ground node to which the ground voltage is supplied. The liquid crystal capacitor CLC may receive the data voltage from the thin-film transistor TFT and charge a pixel voltage corresponding to the data voltage. Accordingly, the first pixel PX1 may display a grayscale corresponding to the pixel voltage. In an embodiment, a liquid crystal layer may be disposed between electrodes of the liquid crystal capacitor CLC.

In an embodiment, when a display panel 110 is implemented with the first pixel PX1, second scan lines SC21 to SC2m may be omitted.

FIG. 3 illustrates an example of an operation of a display panel implemented with the first pixel of FIG. 2. In FIG. 3, for convenience of explanation, a display panel 200 including 7×5 first pixels PX1 is shown.

Referring to FIG. 2 and FIG. 3, when data is updated from a first frame F1 to a second frame F2 of the display panel 200, first to seventh rows R1 to R7 of the display panel 200 may be sequentially updated.

For example, the first row R1 of the display panel 200 may be updated. After the first row R1 of the display panel 200 is updated, the second row R2 of the display panel 200 may be updated. After the second row R2 of the display panel 200 is updated, the third row R3 of the display panel 200 may be updated. After the third row R3 of the display panel 200 is updated, the fourth row R4 of the display panel 200 may be updated. After the fourth row R4 of the display panel 200 is updated, the fifth row R5 of the display panel 200 may be updated. After the fifth row R5 of the display panel 200 is updated, the sixth row R6 of the display panel 200 may be updated. After the sixth row R6 of the display panel 200 is updated, the seventh row R7 of the display panel 200 may be updated.

When the first to seventh rows R1 to R7 of the display panel 200 are sequentially updated, motion blur may occur due to mixture of the first frame F1 and the second frame F2. Furthermore, when applied to a hologram application, the coherence of a holographic optical system may decrease due to color mixing. Accordingly, image quality of the display panel 200 may be reduced.

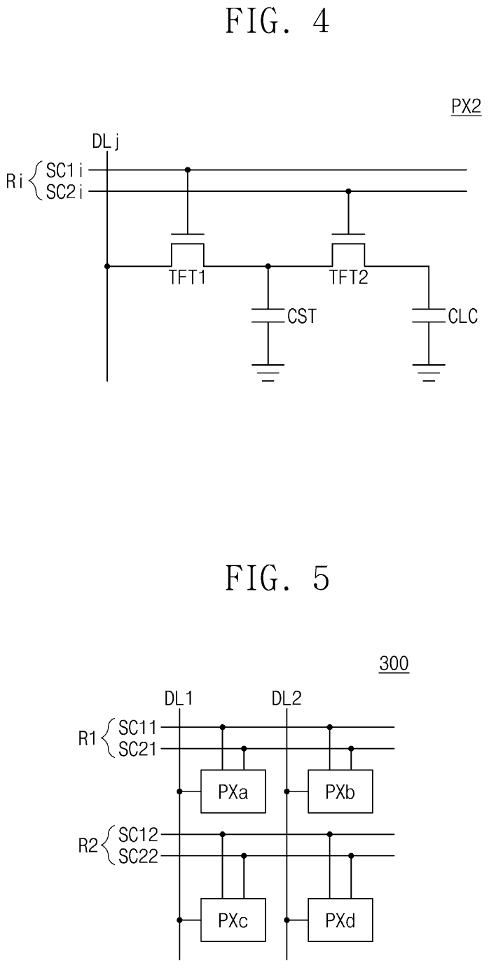

FIG. 4 illustrates an example of a second pixel. Referring to FIG. 1 and FIG. 4, a second pixel PX2 may include a first thin-film transistor TFT1 including a gate connected to a corresponding first scan line SC1i among first scan lines SC11 to SC1m, a first terminal connected to a corresponding data line DLj among data lines DL1 to DLn, and a second terminal.

The second pixel PX2 may include a second thin-film transistor TFT2 including a gate connected to a corresponding second scan line SC2i among second scan lines SC21 to SC2m, a first terminal connected to the second terminal of the first thin-film transistor TFT1, and a second terminal.

The second pixel PX2 may further include a storage capacitor CST connected between the second terminal of the first thin-film transistor TFT1 (or the first terminal of the second thin-film transistor TFT2) and a first ground node to which a ground voltage is supplied. The second pixel PX2 may further include a liquid crystal capacitor CLC connected between the second terminal of the second thin-film transistor TFT2 and a second ground node to which the ground voltage is supplied.

In an embodiment, the first scan line SC1i and the second scan line SC2i may correspond to an i-th row Ri among m rows of a display panel 110.

FIG. 5 illustrates an example of a display panel implemented with the second pixel of FIG. 4. Referring to FIG. 4 and FIG. 5, a display panel 300 may include 2×2 pixels PXa, PXb, PXc, and PXd. Each of the pixels PXa, PXb, PXc, and PXd may be implemented as the second pixel PX2.

In FIG. 5, for convenience of explanation, 2×2 pixels PXa, PXb, PXc, and PXd are shown. However, substantially more pixels may be arranged in the display panel 300.

The pixel PXa may be connected to a corresponding first scan line SC11 among first scan lines SC11 and SC12, a corresponding second scan line SC21 among second scan lines SC21 and SC22, and a corresponding data line DL1 among data lines DL1 and DL2.

The pixel PXb may be connected to the corresponding first scan line SC11 among the first scan lines SC11 and SC12, the corresponding second scan line SC21 among the second scan lines SC21 and SC22, and a corresponding data line DL2 among the data lines DL1 and DL2.

The pixel PXc may be connected to a corresponding first scan line SC12 among the first scan lines SC11 and SC12, a corresponding second scan line SC22 among the second scan lines SC21 and SC22, and the corresponding data line DL1 among the data lines DL1 and DL2.

The pixel PXd may be connected to the corresponding first scan line SC12 among the first scan lines SC11 and SC12, the corresponding second scan line SC22 among the second scan lines SC21 and SC22, and the corresponding data line DL2 among the data lines DL1 and DL2.

In an embodiment, the first scan line SC11 and the second scan line SC21 may correspond to a first row R1 of a display panel 300, and the first scan line SC12 and the second scan line SC22 may correspond to a second row R2 of the display panel 300.

The display panel 300 may display each frame by simultaneously updating the first and second rows R1 and R2. Hereinafter, the operating method of simultaneously updating the first and second rows R1 and R2 may be referred to as a frame update method or a simultaneous emission method.

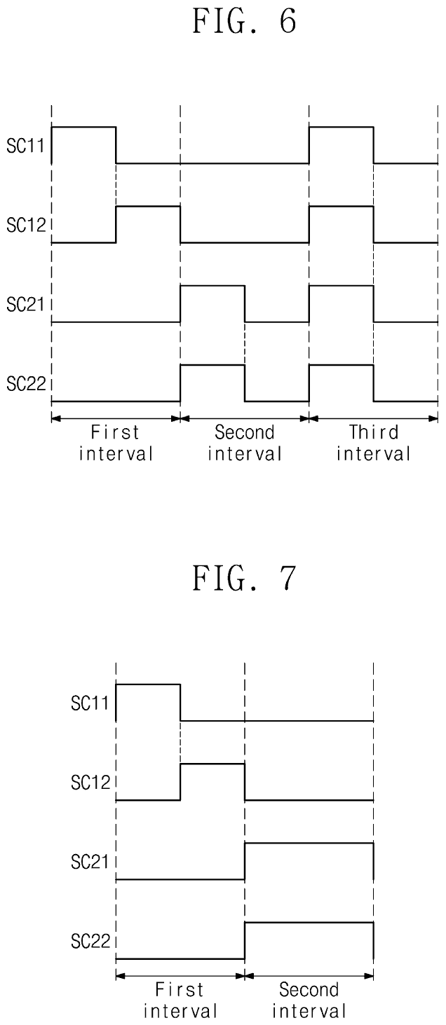

FIG. 6 illustrates a first operating method of the display panel of FIG. 5. Referring to FIG. 4, FIG. 5, and FIG. 6, the first operating method may represent an operating method for displaying a first frame on a display panel 300.

The display panel 300 may operate for a first interval, a second interval, and a third interval to display the first frame. In an embodiment, the first interval may represent a programming interval, the second interval may represent an emission interval, and the third interval may represent a reset interval. The first frame may not be displayed on the display panel 300 in the first interval and the third interval, and may be displayed on the display panel 300 in the second interval.

In FIG. 6, a target voltage may represent a data voltage for inputting data corresponding to the first frame into the display panel 300.

In the first interval, a first scan line SC11 may be controlled to a high level (e.g., a first level or a turn-on level). Accordingly, first thin-film transistors TFT1 of pixels PXa and PXb may be turned on. The turned-on first thin-film transistor TFT1 of the pixel PXa may receive the target voltage through a data line DL1 and provide the received target voltage to a storage capacitor CST of the pixel PXa. The storage capacitor CST of the pixel PXa may charge a voltage corresponding to the provided target voltage.

The turned-on first thin-film transistor TFT1 of the pixel PXb may receive the target voltage through a data line DL2 and provide the received target voltage to a storage capacitor CST of the pixel PXb. The storage capacitor CST of the pixel PXb may charge a voltage corresponding to the provided target voltage.

In the first interval, after the storage capacitors CST of the pixels PXa and PXb have charged the voltage, the first scan line SC11 may be controlled to a low level (e.g., a second level or a turn-off level), and the first scan line SC12 may be controlled to the high level. Accordingly, the first thin-film transistors TFT1 of the pixels PXa and PXb are turned off, and first thin-film transistors TFT1 of pixels PXc and PXd may be turned on. The turned-on first thin-film transistor TFT1 of the pixel PXc may receive the target voltage through the data line DL1 and provide the received target voltage to a storage capacitor CST of the pixel PXc. The storage capacitor CST of the pixel PXc may charge a voltage corresponding to the provided target voltage. The turned-on first thin-film transistor TFT1 of the pixel PXd may receive the target voltage through the data line DL2 and provide the received target voltage to a storage capacitor CST of the pixel PXd. The storage capacitor CST of the pixel PXd may charge a voltage corresponding to the provided target voltage.

In the second interval, the first scan line SC12 may be controlled to the low level. Accordingly, the first thin-film transistors TFT1 of the pixels PXc and PXd may be turned off.

In the second interval, second scan lines SC21 and SC22 may be controlled to the high level. Accordingly, second thin-film transistors TFT2 of the pixels PXa, PXb, PXc, and PXd may be turned on. Therefore, in each of the pixels PXa, PXb, PXc, and PXd, a portion of the voltage charged in the storage capacitor CST may be transferred to a liquid crystal capacitor CLC. That is, in each of the pixels PXa, PXb, PXc, and PXd, the liquid crystal capacitor CLC may charge the voltage transferred from the storage capacitor CST as a pixel voltage. In an embodiment, the pixel voltage may be determined based on capacitance values of the storage capacitor CST and the liquid crystal capacitor CLC.

Subsequently, in the second interval, the second scan lines SC21 and SC22 may be controlled to the low level, and the second thin-film transistors TFT2 of the pixels PXa, PXb, PXc, and PXd may be turned off. Each of the pixels PXa, PXb, PXc, and PXd may display a grayscale corresponding to the pixel voltage. That is, the grayscale (e.g., a frame) displayed on the display panel 300 may be changed based on the pixel voltage.

In the third interval, the first scan lines SC11 and SC12 and the second scan lines SC21 and SC22 may be controlled to the high level. Accordingly, in the pixels PXa, PXb, PXc, and PXd, both the first thin-film transistors TFT1 and the second thin-film transistors TFT2 may be turned on. The pixels PXa and PXc may receive a reset voltage through the data line DL1, and the pixels PXb and PXd may receive the reset voltage through the data line DL2. In response to the reset voltage, the pixels PXa, PXb, PXc, and PXd may initialize the voltage charged in the storage capacitor CST and the liquid crystal capacitor CLC. In an embodiment, the reset voltage may be set to a half potential VDD/2 of the power supply voltage VDD according to a driving method of polarity inversion.

FIG. 7 illustrates a second operating method of the display panel of FIG. 5. Referring to FIG. 4, FIG. 5, and FIG. 7, the second operating method may represent an operating method for displaying a second frame on a display panel 300, which is currently displaying a first frame. In other words, the second operating method may represent an operating method for updating from the first frame to the second frame.

The display panel 300 may operate during a first interval and a second interval to update a displayed frame from the first frame to the second frame. In an embodiment, the first interval may represent a programming interval, and the second interval may represent an emission interval. The first frame may be displayed on the display panel 300 during the first interval, and the second frame may be displayed on the display panel 300 during the second interval.

In FIG. 7, a target voltage may include a reset voltage for initializing data corresponding to the first frame and a data voltage for inputting data corresponding to the second frame.

In the first interval, a first scan line SC11 may be controlled to a high level (e.g., a first level or a turn-on level). Accordingly, first thin-film transistors TFT1 of pixels PXa and PXb may be turned on. The turned-on first thin-film transistor TFT1 of the pixel PXa may receive the target voltage through a data line DL1 and provide the received target voltage to a storage capacitor CST of the pixel PXa. The storage capacitor CST of the pixel PXa may charge a voltage corresponding to the provided target voltage.

The turned-on first thin-film transistor TFT1 of the pixel PXb may receive the target voltage through a data line DL2 and provide the received target voltage to a storage capacitor CST of the pixel PXb. The storage capacitor CST of the pixel PXb may charge a voltage corresponding to the provided target voltage.

In the first interval, after the storage capacitors CST of the pixels PXa and PXb have charged the voltage, the first scan line SC11 may be controlled to a low level (e.g., a second level or a turn-off level), and a first scan line SC12 may be controlled to the high level. Accordingly, the first thin-film transistors TFT1 of the pixels PXa and PXb are turned off, and first thin-film transistors TFT1 of pixels PXc and PXd may be turned on. The turned-on first thin-film transistor TFT1 of the pixel PXc may receive the target voltage through the data line DL1 and provide the received target voltage to a storage capacitor CST of the pixel PXc. The storage capacitor CST of the pixel PXc may charge a voltage corresponding to the provided target voltage.

The turned-on first thin-film transistor TFT1 of the pixel PXd may receive the target voltage through the data line DL2 and provide the received target voltage to a storage capacitor CST of the pixel PXd. The storage capacitor CST of the pixel PXd may charge a voltage corresponding to the provided target voltage.

Meanwhile, in the first interval, liquid crystal capacitors CLC of the pixels PXa, PXb, PXc, and PXd may be charged state with a first pixel voltage corresponding to the first frame. Accordingly, the display panel 300 may display the first frame during the first interval.

In the second interval, the first scan line SC12 may be controlled to the low level. Accordingly, the first thin-film transistors TFT1 of the pixels PXc and PXd may be turned off.

In the second interval, second scan lines SC21 and SC22 may be controlled to the high level. Accordingly, second thin-film transistors TFT2 of the pixels PXa, PXb, PXc, and PXd may be turned on. Therefore, in each of the pixels PXa, PXb, PXc, and PXd, a portion of the voltage charged in the storage capacitor CST may be transferred to the liquid crystal capacitor CLC. In each of the pixels PXa, PXb, PXc, and PXd, the liquid crystal capacitor CLC may be charged with a second pixel voltage corresponding to the second frame, based on the voltage transferred from the storage capacitor CST. In an embodiment, the second pixel voltage may be determined based on capacitance values of the storage capacitor CST and the liquid crystal capacitor CLC.

Subsequently, in the second interval, each of the pixels PXa, PXb, PXc, and PXd may display a grayscale corresponding to the second pixel voltage. The display panel 300 may initialize the data corresponding to the first frame and display the data corresponding to the second frame. That is, the first frame displayed on the display panel 300 may be changed to the second frame based on the second pixel voltage.

In an embodiment, the reset voltage may represent a voltage for initializing (or removing) the data corresponding to the first frame for a driving method of polarity inversion.

Meanwhile, in FIG. 7, a range of the target voltage may be increased based on the capacitance values of the storage capacitor CST and the liquid crystal capacitor CLC. This is to remove the data voltage applied to the previous frame (e.g., first frame) and apply the data voltage corresponding to the next frame (e.g., second frame) without turning off the display panel 300. For example, the target voltage (or the range of the target voltage) may be determined based on the following Equation 1.

$${V}^{′} = \frac{V 1 \cdot C 1 + V 2 \cdot C 2}{C 1 + C 2} \qquad [ Equation 1 ]$$

In Equation 1, C1 may represent a capacitance value of a storage capacitor CST, C2 may represent a capacitance value of a liquid crystal capacitor CLC, V1 may represent a data voltage of a next frame (e.g., second frame), V2 may represent a data voltage of a previous frame (e.g., first frame), and V′ may represent a target voltage.

Referring to Equation 1, if it is assumed that a range of a previous target voltage is 0 V to 10 V, the capacitance value C1 of the storage capacitor CST is 40 fF, and the capacitance value C2 of the liquid crystal capacitor CLC is 10 fF, a range of a next target voltage may be increased to −2.5 V to 12.5 V according to a driving method of polarity inversion. Specifically, if it is assumed that a reset voltage is 5 V, the data voltage of a next frame (e.g., second frame) may be 5+a V, the data voltage of a previous frame (e.g., first frame) may be 5−b V, and the target voltage may be 5+c V according to the driving method of the polarity inversion. According to the above values and Equation 1, Equation 2 may be derived.

$$5 + c = \frac{( 5 + a ) \cdot 40 fF + ( 5 - b ) \cdot 10 fF}{50 fF} \qquad [ Equation 2 ]$$

Based on the result of Equation 2, a=1.25c−0.25b, and accordingly, a of the data voltage of the next frame (e.g., second frame) may be the sum of −25% (−C2/C1) of b of the data voltage of the previous frame (e.g., first frame) and 125% ((C1+C2)/C1) of c of the target voltage. In this way, by applying two voltages at once, the data voltage applied to the previous frame (e.g., first frame) may be removed and the data voltage corresponding to the next frame (e.g., second frame) may be applied without the display turning off.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

The display device 100 according to the present disclosure may minimize motion blur and improve coherence of a hologram display. Thus, the clarity of the display device 100 may be increased.

The display device 100 according to the present disclosure may be implemented by minimizing the area.

According to the present disclosure, since a range of a data voltage is increased, the display device 100 that is robust against noise may be implemented.

According to the present disclosure, since a sufficient emission timing may be secured by removing a reset timing, power consumption may be reduced.

What is claimed is:

1. A display device comprising:
pixels arranged in rows and columns;
a gate driver connected to the rows of the pixels through first scan lines and second scan lines respectively corresponding to the first scan lines; and
a data driver connected to the columns of the pixels through data lines,
wherein the pixels are configured to:
receive target voltages through the data lines in a first interval, and
charge pixel voltages based on the target voltages in a second interval.

2. The display device of claim 1, wherein the pixels include:
first transistors including a gate connected to a corresponding first scan line among the first scan lines, a first terminal connected to a corresponding data line among the data lines, and a second terminal; and
second transistors including a gate connected to a corresponding second scan line among the second scan lines, a first terminal connected to the second terminal of the first transistors, and a second terminal.

3. The display device of claim 2, wherein the second transistors are simultaneously turned on based on a voltage of the corresponding second scan line among the second scan lines.

4. The display device of claim 3, wherein the pixels include first capacitors and second capacitors,
wherein each of the first capacitors is connected to the second terminal of a corresponding first transistor among the first transistors and the first terminal of a corresponding second transistor among the second transistors, and
wherein each of the second capacitors is connected to the second terminal of a corresponding second transistor among the second transistors.

5. The display device of claim 4, wherein the target voltages represent data voltages for inputting data corresponding to a first frame.

6. The display device of claim 5, wherein in the first interval, the first transistors are sequentially turned on based on a voltage of the corresponding first scan line among the first scan lines.

7. The display device of claim 6, wherein in response to the first transistors being turned on in the first interval, the first capacitors charge the target voltages.

8. The display device of claim 7, wherein in response to the second transistors being turned on in the second interval, the second capacitors charge the pixel voltages based on the target voltages.

9. The display device of claim 8, wherein, in a third interval, the pixels are configured to:
receive reset voltages through the data lines; and
initialize data corresponding to the first frame in response to the reset voltages.

10. The display device of claim 9, wherein the pixels display the first frame in the second interval.

11. The display device of claim 4, wherein each of the target voltages includes a reset voltage for initializing data corresponding to a first frame and a data voltage for inputting data corresponding to a second frame.

12. The display device of claim 11, wherein in the first interval, the first transistors are sequentially turned on based on a voltage of the corresponding first scan line among the first scan lines.

13. The display device of claim 12, wherein in response to the first transistors being turned on in the first interval, the first capacitors charge the target voltages.

14. The display device of claim 13, wherein in the first interval, the second capacitors are in a charged state with first pixel voltages corresponding to the first frame, and
the pixels display the first frame.

15. The display device of claim 14, wherein in response to the second transistors being turned on in the second interval, the second capacitors are charged with second pixel voltages corresponding to the second frame.

16. The display device of claim 15, wherein in response to the second transistors being charged with the second pixel voltages in the second interval, the pixels display the second frame.

17. A method of operating a display panel including first transistors, second transistors, first capacitors, and second capacitors, the method comprising:
sequentially turning on the first transistors through first scan lines in a first interval;
receiving, by the first transistors, target voltages through data lines in response to turning on the first transistors in the first interval;
charging, by the first capacitors, the target voltages in the first interval;
simultaneously turning on the second transistors in a second interval; and
charging, by the second capacitors, pixel voltages based on the target voltages in response to turning on the second transistors in the second interval.

18. The method of claim 17, wherein the target voltages represent data voltages for inputting data corresponding to a first frame.

19. The method of claim 18, further comprising:
receiving, by the first transistors, reset voltages through the data lines in a third interval; and
initializing data corresponding to the first frame in response to the reset voltages.

20. The method of claim 17, wherein each of the target voltages includes a reset voltage for initializing data corresponding to a first frame and a data voltage for inputting data corresponding to a second frame.
